(19) United States
(12) Patent Application Publication
(10) Pub. No.: US 2015/0224899 A1
(43) Pub. Date: Aug. 13, 2015

(54) ROTOMOLDED SEAT

(71) Applicant: PREMIER PLASTICS, INC., Hoyt Lakes, MN (US)

(72) Inventor: Robert J. Menne, III, Virginia, MN (US)

(73) Assignee: Premier Plastics, Inc., Hoyt Lakes, MN (US)

(21) Appl. No.: 14/427,055

(22) PCT Filed: Sep. 12, 2013
(86) PCT No.: PCT/US2013/059372

§ 371 Date: Mar. 10, 2015

Related U.S. Application Data
(60) Provisional application No. 61/700,101, filed on Sep. 12, 2012.

(51) Int. Cl. B60N 2/44; B60N 2/68

(52) U.S. Cl. CPC B60N 2/4415; B60N 2/68

(57) ABSTRACT

Embodiments of the invention are directed to a seat assembly comprising rotomolded seat members. In some embodiments, the seat assembly comprises a rotomolded, compliant base seat member having a wall that defines a first interior chamber a rotomolded, compliant back seat member having a wall that defines a second interior chamber, and a frame attached to the base seat member. The wall of the base seat member contacts the frame. A bottom portion of the back seat member is positioned adjacent the base seat member, the back seat member has an orientation that is transverse to the base seat member.

### BACKGROUND

Vehicle seating preferably accommodates a wide range of users to support the users in comfort. Seating for some vehicles, such as all-terrain vehicles, snowmobiles, lawnmowers, tractors, boats, and personal watercraft, are subjected to wind, rain, submersion in water and other environmental conditions. Conventional seats used with such vehicles tend to absorb water affecting their comfort and durability. Also, the absorbed water can affect the performance of the vehicle due to the increased weight.

### SUMMARY

In some embodiments, the seat assembly comprises a rotomolded, compliant base seat member and a rotomolded, compliant back seat member. The base seat member includes a first interior chamber. The back seat member is connected to the base seat member and includes a second interior chamber. A bottom portion of the back seat member is positioned adjacent the base seat member, and the back seat member has an orientation that is transverse to the base seat member.

In some embodiments, the base seat member and the back seat member are waterproof and do not absorb water.

In some embodiments, the seat assembly includes a frame that is attached to the base seat member and the back seat member. The frame supports the base seat member and the back seat member in fixed relative positions.

In some embodiments, the base seat member includes a first port for inflating and deflating the first interior chamber. In some embodiments, the back seat member includes a second port for inflating or deflating the second interior chamber.

In some embodiments, the seat assembly is attached to a vehicle. In some embodiments, the vehicle is a wheelchair, a mobility scooter, an all-terrain vehicle, a snowmobile, a lawnmower, a tractor, a boat, or a personal watercraft.

In some embodiments, the base member includes side portions positioned on opposing sides of a central portion. In some embodiments, the first interior chamber is formed within the central portion. In some embodiments, the first interior chamber is formed within the central portion and the side portions.

In some embodiments, the seat assembly includes an air pump that is coupled to the first port of the base seat member and/or the second port of the back seat member. The air pump is configured to inflate one or both of the interior chambers.

In some embodiments, the seat assembly includes a fluidic coupling between the first and second interior chambers. This allows both the first and second interior chambers to be inflated through the first or second port.

In some embodiments, the seat assembly comprises a rotomolded, compliant headrest member having an interior chamber. The headrest member is connected to the back seat member and positioned adjacent a top portion of the back seat member that is opposite the bottom portion. In some embodiments, the headrest member includes a port for inflating or deflating the interior chamber of the headrest member.

In some embodiments, the seat assembly includes rotomolded, compliant lateral support members each having an interior chamber. The lateral support members are connected to the back seat member on opposing sides of the back seat member and extend between the top and bottom portions. In some embodiments, each of the lateral support members includes a port for inflating or deflating the interior chamber of the lateral support member.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is an exploded perspective view of the seat assembly in accordance with embodiments of the invention.

FIG. 2 is a simplified front view of a seat assembly in accordance with embodiments of the invention.

FIG. 3 is a simplified cross-sectional diagram of the seat assembly in accordance with embodiments of the invention.

FIG. 4 is a block diagram of a seat assembly illustrating exemplary fluidic connections between a pump and interior chambers of components of the seat assembly, in accordance with embodiments of the invention.

FIG. 5 is a flowchart illustrating a method of manufacturing a seat assembly in accordance with embodiments of the invention.

### DETAILED DESCRIPTION OF ILLUSTRATIVE EMBODIMENTS

Embodiments of the invention are described more fully hereinafter with reference to the accompanying drawings. Elements that are identified using the same or similar reference characters refer to the same or similar elements. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention may also be described using flowchart illustrations and block diagrams. Although a flowchart may describe the operations as a sequential process, many of the operations can be performed in parallel or concurrently. In addition, the order of the operations may be re-arranged. A process is terminated when its operations are completed, but could have additional steps not included in a figure or described herein.

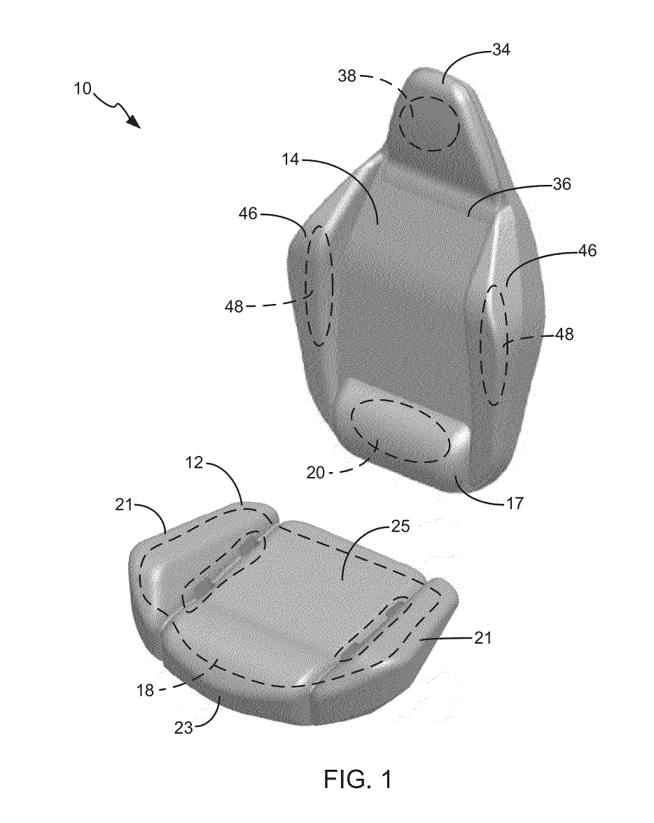

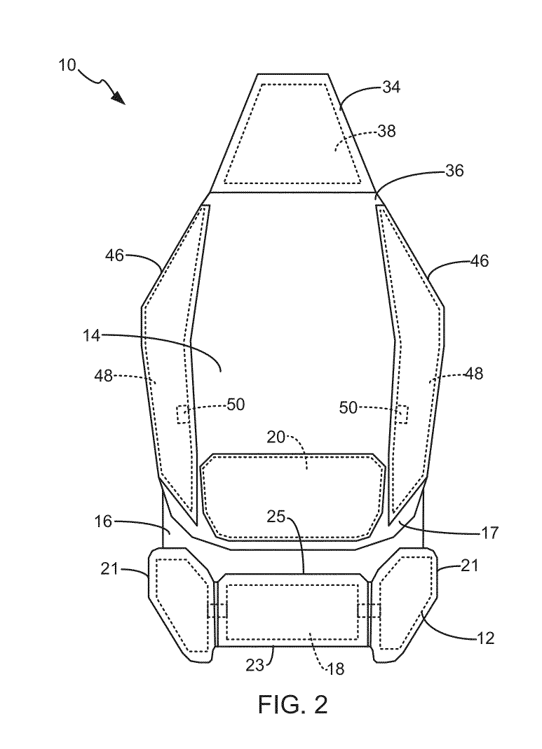

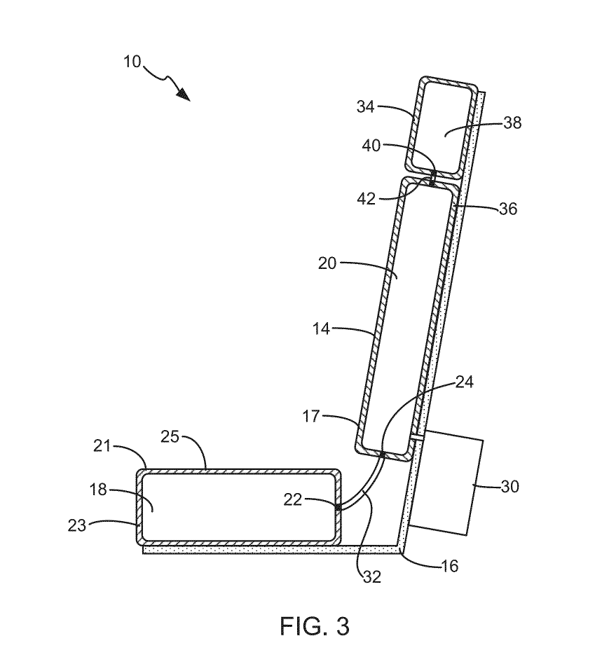

Embodiments of the invention are directed to a seat assembly 10. Embodiments of the seat assembly 10 will initially be described with reference to FIGS. 1-3. FIG. 1 is an exploded perspective view of the seat assembly 10 in accordance with embodiments of the invention. FIG. 2 is a simplified front view of the seat assembly 10 in accordance with embodiments of the invention. FIG. 3 is a simplified cross-sectional diagram of the seat assembly 10 illustrating embodiments of the invention. Embodiments of the seat assembly 10 can provide a durable, economical, comfortable, resilient, waterproof and adjustable seat that may be useful for a number of seating applications. In some embodiments, the seat assembly is configured for use with a vehicle. In some embodiments, the seat assembly is configured for use with outdoor vehicles including, for example, all-terrain vehicles, snowmobiles, lawnmowers, tractors, boats, personal watercraft, and other outdoor vehicles. In some embodiments, the seat assembly is configured for use with a wheelchair, a mobility scooter, or other vehicle. Embodiments of the invention include the attachment of the seat assembly to at least one of the above-described vehicles. In some embodiments, the seat assembly is configured as a fixed or movable chair.

In some embodiments, the seat assembly 10 includes members that are formed using a rotomolding, or rotational molding process. Rotomolding is typically a lower-speed manufacturing process than, for example, injection molding. Usually, only one or two rotomolding cycles can occur within an hour. However, rotomolding does provide distinct advantages over other types of manufacturing. For example, manufacturing large, hollow parts, such as oil tanks is much easier using rotomolding than any other manufacturing method. Additionally, rotational molds are significantly cheaper than other types of manufacturing molds. Further, very little material is wasted using the rotomolding process, since excess material can often be re-used making it a very economical and environmentally viable manufacturing process.

The rotomolding process typically consists of four distinct phases. In a first phase, a measured quantity of polymer (usually in powder or liquid form) is loaded into a mold that is configured for biaxial rotation (i.e., angular rotation about two axes). Next, in the second phase, the mold is heated in an oven while the mold rotates about the axes. This phase continues until all polymer has melted and adhered to the mold wall. In the third stage, the mold is cooled, typically using a fan. This stage of the cycle can be quite lengthy. The polymer must be cool so that it solidifies and can be handled safely by the operator. The cooling process can take tens of minutes. As the part or component cools, it will shrink, thereby coming away from the mold and facilitating easy removal.

In some embodiments, the seat assembly 10 comprises a rotomolded, compliant base seat member 12 and a rotomolded, compliant back seat member 14, as shown in FIGS. 1-3. In some embodiments, the members 12 and 14 are waterproof. In some embodiments, the base seat member 12 and the back seat member 14, as well as other members of the assembly 10 described herein, are formed using rotomolding processes. In some embodiments, the polymeric material used to form the members of the assembly 10 is compliant and pliable, such as that used for boat buoy or dock bumpers, to provide some give to cushion the user. In some embodiments, the polymeric material is polyvinyl chloride. Additionally, in some embodiments, the material forming the seat members 12, 14 and other seat members described herein may be exposed to the outdoors without absorbing water.

In some embodiments, the base seat member 12 and the back seat member 14 are connected to each other either directly or through a shell or other suitable frame 16, as shown in FIGS. 2 and 3. In some embodiments, the connection of the base seat member 12 to the back seat member 14 fixes the relative orientations of the base seat member 12 to the back seat member 14. In some embodiments, a bottom portion 17 of the back seat member 14 is positioned adjacent the bottom seat member 12. In some embodiments, the back seat member 12 has an orientation that is transverse to the base seat member 14, as shown in FIG. 3.

In some embodiments, the base seat member 12 and the back seat member 14 respectively include interior chambers 18 and 20, as shown in FIGS. 2 and 3. The chambers 18 and 20 are configured to absorb/disburse energy from bouncing while operating the vehicle to which the seat assembly 10 is attached.

In some embodiments, the base seat member 12 includes side portions 21 positioned on opposing sides of a central portion 23. In some embodiments, the side portions 21 extend above a top surface 25 of the central portion 23, as shown in FIG. 2, and provide lateral support to the upper legs of a user seated on the central portion 23.

In some embodiments, the chamber 18 is formed within the central portion 23. In some embodiments, the chamber 18 is formed within the central portion 23 and the side portions 21.

In some embodiments, the base seat member includes a port 22 and the back seat member 14 includes a port 24, as shown in FIG. 3. The chambers 18 and 20 may be filled with air to a desired pressure, or filled with another material, such as gel or foam, to create varying densities depending on damping requirements, through the respective ports 22 and 24. In some embodiments, the ports 22 and 24 are in the form of an air receptacle of a basketball, or other suitable port. Thus, embodiments of the seat assembly 10 provide a relatively low cost seat that is only waterproof due to the compliant polymer used to form the seat members 12 and 14, but also compliant to a selected degree based upon the pressure maintained in the chambers 18 and 20 of the base seat member 12 and the back seat member 14.

To facilitate the controlled pressurization of the chambers 18 and 20 of the base seat member 12 and back seat member 14, some embodiments of seat assembly 10 include an air pump 30. Embodiments of the air pump 30 include a hand pump or an air compressor. In some embodiments, the air compressor 30 may be powered using its own battery, through a battery or generator of the vehicle with which the seat assembly 10 is being used, or other power source.

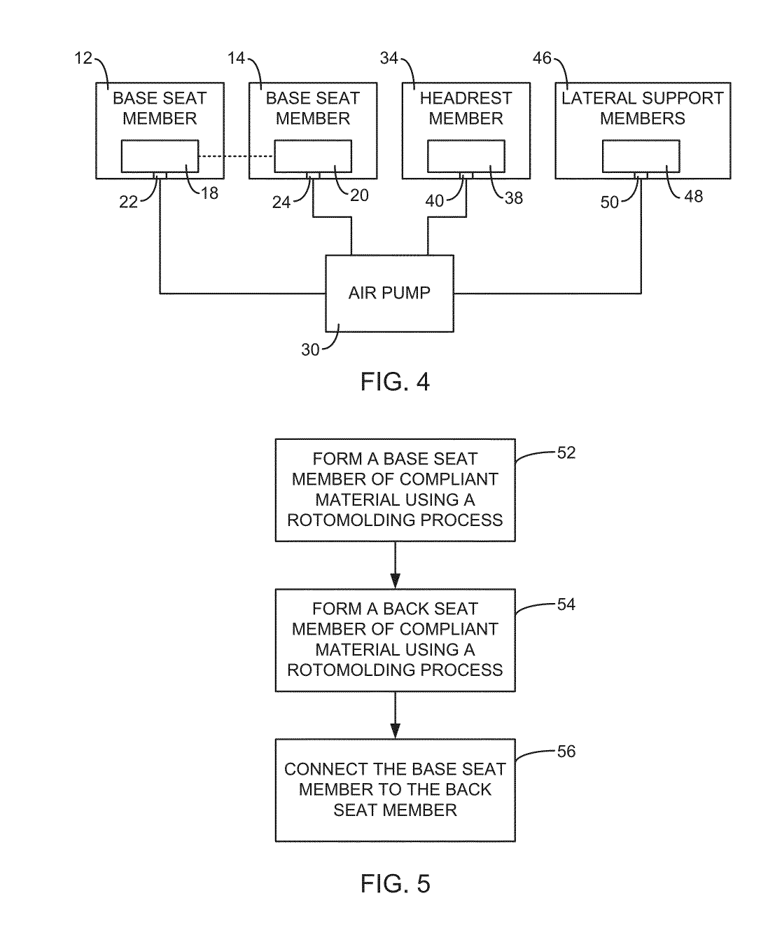

FIG. 4 is a block diagram of the seat assembly 10 illustrating exemplary fluidic connections between the pump 30 and the chambers of components of the seat assembly 10, such as the members 12 and 14, in accordance with embodiments of the invention. In some embodiments, the air pump 30 is connected to one or both of the seat members 12 and 14. In some embodiments, the air pump 30 is connected to the frame 16, as shown in FIG. 3. In some embodiments, the air pump 30 may be selectively coupled to the desired port 22 or 24 to inflate the corresponding chamber.

In some embodiments, the chambers 18 and 20 are fluidically coupled together, as indicated by the dashed line in FIG. 4, to maintain the pressures within the chambers 18 and 20 at the same levels. In some embodiments, the ports 22 and 24 may be fluidically coupled together through tubing 32, as shown in FIG. 3. In some embodiments, the air pump 30 is fluidically coupled to the chamber 20 of the back seat member 14. As the air pump 30 pumps air into the chamber 20, air is simultaneously fed into the chamber 18 to control the pressurization of both the chambers 18 and 20 due to the fluidic coupling of the chambers 18 and 20. This feature of the assembly 10 may alternatively be facilitated through the coupling of the air pump 30 to the chamber 18 of the base seat member 12.

In some embodiments, the seat assembly 10 comprises other rotomolded, compliant and waterproof members. In some embodiments, the seat assembly 10 includes a rotomolded, compliant headrest member 34 connected to the back seat member 14 and positioned adjacent a top portion 36 of the back seat member 14 that is opposite the bottom portion 17. In some embodiments, the headrest member 34 may be directly coupled to the back seat member 14, or integrated with the back seat member 14. In some embodiments, the headrest member 34 may be connected to the back seat member 14 through the frame 16, as shown in FIG. 3.

In some embodiments, the headrest member 34 includes an interior chamber 38, as shown in FIGS. 1-4. In some embodiments, the headrest member 34 includes a port 40, through which the interior chamber 38 may be filled with air or other suitable material to provide the desired cushioning for the headrest member 34. In some embodiments, the chamber 38 may be fluidically coupled to one or more of the other chambers, such as the chamber 20 of the back seat member 14 (FIG. 3) through a suitable fluidic coupling 42. In some embodiments, the chamber 38 is fluidically coupled to the pump 30.

In some embodiments, the seat assembly 10 includes a pair of rotomolded, compliant lateral support members 46, which are connected to opposing sides of the back seat member 14, and extend between the top portion 36 and the bottom portion 17, as shown in FIGS. 1 and 2. The lateral support members 46 protrude from the sides of the backseat member 14 to provide lateral support for a person sitting in the seat assembly 10. As with the headrest member 34, the lateral support members 46 may be directly connected to, or integrated with, the backseat member 14, or connected to the backseat member 14 through the frame 16.

In some embodiments, the lateral support members 46 each include an interior chamber 48, as shown in FIGS. 1, 2 and 4. In some embodiments, the chambers 48 each include a port 50 through which the chambers may be inflated or deflated using air or other suitable material. The degree to which the chambers 48 of the lateral support members 46 are inflated affects the amount of lateral support provided by the members 46. As with the other chambers described herein, the chambers 48 of the lateral support members 46 may be fluidically coupled to one or more of the other chambers, such as the chamber 20 of the back seat member 14, or to each other, to facilitate even pressurization of the chambers. In some embodiments, the chambers 48 are fluidically coupled to the pump 30.

FIG. 5 is a flowchart illustrating a method of manufacturing a seat assembly in accordance with embodiments of the invention. At 52 of the method, a base seat member 12 having an interior chamber 18 is formed of compliant material using a rotomolding process. At 54, a back seat member 14 is formed of compliant material using a rotomolding process. At 56, the base seat member 12 is connected to the back seat member 14. A bottom portion 17 of the back seat member is positioned adjacent the base seat member, and the back seat member has an orientation that is transverse to the base seat member. In some embodiments, the base seat member 12 and the back seat member 14 are attached to a frame 16.

In some embodiments, the interior chamber 18 of the base seat member 12 is inflated. In some embodiments, a pump 30 is used to drive air into the chamber 18 through a port 22. In some embodiments, the inflation of the chamber 18 simultaneously inflates another chamber of the assembly 10, such as a chamber 20 of the back seat member 14, through a fluidic coupling between the chambers 18 and 20.

In some embodiments of the method, a headrest member 34 is formed of compliant material using a rotomolding process. In some embodiments, the headrest member 34 is connected to the back seat member 14 either directly or through the frame 16. In some embodiments of the method, a chamber 38 of the headrest member is inflated using a pump 30.

In some embodiments of the method, lateral support members 46 are formed of compliant material using a rotomolding process. In some embodiments, the lateral support members 46 are connected to the back seat member 14 either directly or through the frame 16. In some embodiments, chambers 48 of the lateral support members 46 are inflated using a pump 30.

Although the present invention has been described with reference to preferred embodiments, workers skilled in the art will recognize that changes may be made in form and detail without departing from the spirit and scope of the invention.

1. A seat assembly comprising:
a rotomolded, compliant base seat member having a wall that defines a first interior chamber;
a rotomolded, compliant back seat member having a wall that defines a second interior chamber; and
a frame attached to the base seat member;
wherein:
the wall of the base seat member contacts the frame; and
a bottom portion of the back seat member is positioned adjacent the base seat member, and the back seat member has an orientation that is transverse to the base seat member.

2. The seat assembly of claim 1, wherein the wall of the back seat member contacts the frame, which, supports the base seat member and the back seat member in fixed relative positions.

3. The seat assembly of claim 1, wherein the base seat member includes a first port for inflating or deflating the first interior chamber.

4. The seat assembly of claim 3, further comprising an air pump fluidically coupled to the first interior chamber and configured to inflate the first interior chamber.

5. The seat assembly of claim 3, wherein;
the back seat member includes and a second port for inflating or deflating the second interior chamber; and
the wall of the back seat member contacts the frame.

6. The seat assembly of claim 5, including a fluidic coupling between the first and second interior chambers, wherein both the first and second interior chambers are maintained at the same pressure.

7. The seat assembly of claim 1, further comprising a rotomolded, compliant headrest member connected to the back seat member adjacent a top portion of the back seat member that is opposite the bottom portion.

8. (canceled)

9. The seat assembly of claim 7, further comprising rotomolded, compliant lateral support members connected to opposing sides of the back seat member and extending between the bottom portion and a top portion of the back seat member, wherein each lateral support member includes an interior cavity defined by a wall, and a port for inflating and deflating the interior cavity of the lateral support member. and the wall of each lateral support contacts the frame.

10. (canceled)

11. A seat assembly comprising:
a rotomolded, compliant base seat member having a first interior chamber defined by a wall;
a rotomolded, compliant back seat member adjacent the base seat member and having an orientation that is transverse to the base seat member;
a rotomolded, compliant headrest member connected to the back seat member adjacent a top portion of the back seat member that is opposite the bottom portion;
rotomolded, compliant lateral support members connected to opposing sides of the back seat member and extending between the top and bottom portions; and
a frame in contact with the wall of the base seat member.

12. The seat assembly of claim 11, wherein the frame contacts a wall of the back seat member and supports the base seat member and the back seat member in fixed relative positions.

13. The seat assembly of claim 12, wherein the headrest member and the lateral support members are each connected to one of the frame and the back seat member.

14. The seat assembly of claim 11, wherein the first interior chamber includes a port for inflating and deflating the chamber.

15. The seat assembly of claim 14, further comprising an air pump coupled to the port of the first interior chamber.

16. The seat assembly of claim 14, wherein at least one of the back seat member, the headrest member and the lateral support members include an interior chamber and a port for inflating and deflating the interior chamber.

17. The seat assembly of claim 14, wherein:
the first interior chamber and at least one interior chamber of the back seat member, the headrest member and the lateral support members are fluidically coupled together; and
inflation of one of the interior chambers inflates the other interior chambers.

18. A method of manufacturing a seat assembly comprising:
forming a base seat member of compliant material using a rotomolding process, the base seat member including an interior chamber defined by a wall;
forming a back seat member of compliant material using a rotomolding process;
connecting the base seat member to a frame, wherein the wall of the base seat member contacts the frame.

19. The method of claim 18, further comprising inflating the interior chamber using a pump.

20. The method of claim 18, further comprising:
forming at least one of a headrest member and a pair of lateral support members of compliant material using a rotomolding process; and
connecting at least one of the headrest member and the lateral support members to the back seat member.
